(19) United States
(12) Patent Application Publication
(10) Pub. No.: US 2007/0084945 A1
(43) Pub. Date: Apr. 19, 2007

(54) Indoor fountain

(76) Inventor: Kuo-Jui Wei, Taipei City (TW)

Correspondence Address: PRO-TECHTOR INTERNATIONAL SERVICES, 20775 NORADA CT., SARATOGA, CA, 95070, US

(21) Appl. No.: 11/371,646

(22) Filed: Mar. 9, 2006

(30) Foreign Application Priority Data
Oct. 18, 2005 (CN) 200520105778.5

(51) Int. Cl. F21S 8/00

(52) U.S. Cl. 239/18; 239/17; 239/22

(57) ABSTRACT

An indoor fountain includes a basin, a base, a central artificial decoration device, and a plurality of LEDs disposed on a cover. The basin comprises a bowl-shaped body. The cover is disposed on the top of the basin body. A hollow water tank is defined between the cover and the basin body. The base is disposed under the bottom of the basin. A control switch is disposed on the base. The central artificial decoration device is disposed in the center of the top surface of the cover. A plurality of holes is defined in the cover surrounding the central artificial decoration device. A plurality of nozzles is defined in the cover surrounding the central artificial decoration device. The nozzles are connected to the water tank. When the control switch is turned on, the nozzles spurt water from the water tank and the LEDs emit light.

### RELATED APPLICATIONS

The present application is based on, and claims priority from, China Application Serial Number 200520105778.5, filed Oct. 18, 2005, the disclosure of which is hereby incorporated by reference herein in its entirety.

### FIELD OF THE INVENTION

The present invention relates to a fountain display, and particularly to an indoor fountain for indoor use.

### BACKGROUND OF THE INVENTION

Many small fountains are being sold on the market now. One type employs a submersible pump to supply water to a water dispenser and then mechanically spurt water in accordance with the height of the lift of the pump. Another type employs a submersible pump to supply water to a variable velocity mechanical control valve and then spurt water according to the design of the fountain. A conventional large indoor fountain is only suitable for use in public such as in a square or a park, not inside a home. With increases in living standards and trends toward more amusive home interior decoration, homeowners increasingly desire interior displays, such as indoor fountains. However, conventional mechanical fountains cannot easily accommodate indoor home use.

### SUMMARY OF THE INVENTION

Accordingly, an object of the present invention is to provide an indoor fountain which not only provides the traditional look and feel of a fountain indoors, but also beautifies the home's interior decoration and has functions of shining colored light and playing music for amusement.

To achieve the above object, an indoor fountain of the present invention includes a basin, a base, a central artificial decoration device, and a plurality of LEDs disposed at a cover. The basin comprises a bowl-shaped body with a cover disposed at the top of the basin body. A hollow water tank is defined between the cover and the basin body. The base is disposed at the bottom of the basin. A control switch is disposed at the base. The central artificial decoration device is disposed in the center and at the top of the cover. A plurality of holes is defined in the cover surrounding the central artificial decoration device. A plurality of nozzles is defined in the cover surrounding the central artificial decoration device. The nozzles are connected to the water tank. When the control switch at the base is turned on, the nozzles spurt water from the water tank and the LEDs emit colorful lights.

The LEDs surrounding the central artificial decoration device are equidistantly arranged among the holes. The LEDs alternately emit different colors of light.

The indoor fountain further includes an audible music player. The music player is disposed at the bottom of the base and stores a plurality of different songs.

The control switch at the base is defined with a recess and a control pole is disposed in the recess that can be manually set to three different positions, ON1, OFF and ON2, for achieving three different functions.

When the control pole is set to the ON1 position in the recess, the nozzles spurt water columns, the LEDs emit light, and the music player plays music; and when the control pole is set to the ON2 position in the recess, the nozzles spurt water columns, and the LEDs emit light.

The height of the water columns spurted from the nozzles is varied regularly.

Compared with the prior art, the indoor fountain of the present invention has the following effects. It may be put on a table, a windowsill, a pedestal, or the ground, which not only provides the traditional look and feel of a fountain indoors, but also beautifies the home environment and has functions of emitting colored light and playing music through the LEDs and the music player. Furthermore, the water columns, light and music are regularly varied. Therefore, the indoor fountain of the present invention offers more amusement and provides better enjoyment.

These and other embodiments, aspects and features of the present invention are better understood from a detailed description of the preferred embodiments of the invention, which are further described below in conjunction with the accompanying figures.

### BRIEF DESCRIPTION OF THE DRAWINGS

FIG. 1 is a perspective view of an indoor fountain of the present invention; and

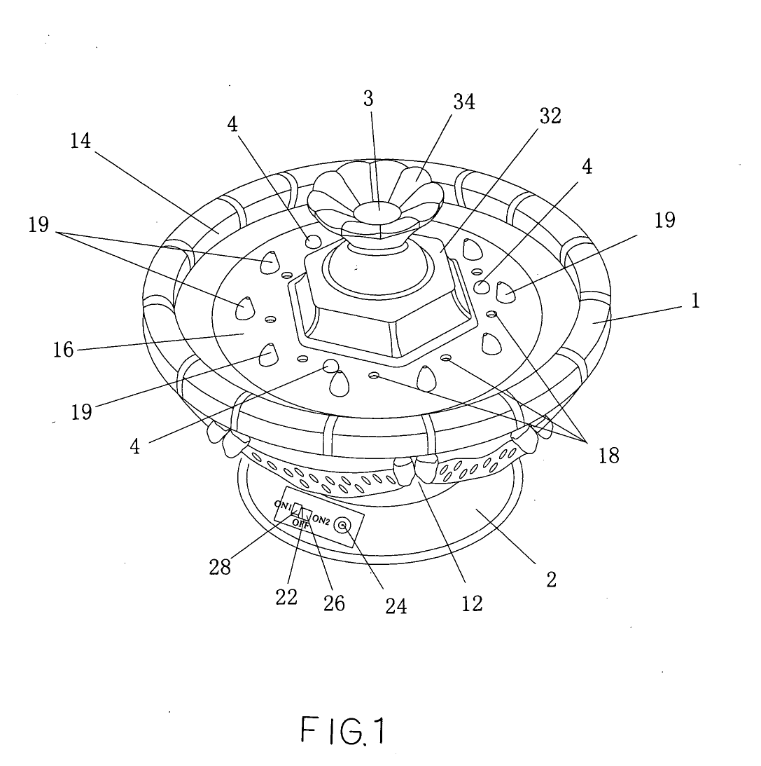

FIG. 2 is a circuit diagram of the indoor fountain of the present invention.

### DETAILED DESCRIPTION OF THE PREFERRED EMBODIMENT

An indoor fountain of the present invention includes a basin 1, a base 2, a central artificial decoration device 3, three LEDs (light-emitting diodes) 4 and an audible music player (not shown).

The basin 1 includes a bowl-shaped body 12. A bowl opening 14 is defined in the top of the basin body 12. A cover 16 is disposed on the basin body 12 slightly below the top flange of the bowl opening 14. A hollow water tank (not shown) is defined between the cover 16 and the basin body 12. Decorative color fringes are disposed on the exterior of the basin body 12.

The base 2 is disposed under the bottom of the basin 1. The base 2 is disposed with a control switch 22 and a power jack 24. The control switch 22 is defined with a recess 26, and a control pole 28 is disposed in the recess 26. The control pole 28 may be manually set to three positions, left, middle and right, in the recess 26 for respectively controlling to achieve three different functions. The left position is marked as ON1, the middle position is marked as OFF, and the right position is marked as ON2. When the control pole 28 is located at the OFF position, the indoor fountain is turned off. When the control pole 28 is located at the ON1 or ON2 position, the indoor fountain provides different effects (described later). The base 2 is disposed with three feet (not shown) under the bottom thereof for standing on a ground or a table to support the whole indoor fountain. The bottom of the base 2 is disposed with a battery box (not shown) and defined with a plurality of apertures (not shown) for transmission of sound of the music player.

The central artificial decoration device 3 is disposed at the center of the upper surface of the cover 16. A seat 32 is disposed at the bottom of the central artificial decoration device 3. A decoration member 34 such as blooming flower, fairy, deity, snowman, is disposed at the top of the seat 32. A plurality of holes 18 is defined in the cover 16 surrounding the central artificial decoration device 3. A plurality of upwardly slanting nozzles 19 is defined in the cover 16 surrounding the holes 18. The nozzles 19 are connected to the water tank between the cover 16 and the basin body 12. The water tank is disposed with a submersible pump (not shown), a water dispenser (not shown) and so on for spurting water from the nozzles 19. The principle and implemental method of spurting water is a prior art and so is not described in detailed herein. After a proper quantity of water is added from the holes 18 to the water tank, when the control pole 28 is located at the ON1 or ON2 position, the nozzles 19 spurt water and the water columns inwardly rush up the central artificial decoration device 3. The height of the spurted water columns are varied regularly. The spurted water flows back to the water tank through the holes 18 and so they are recycled.

The three LEDs 4 are disposed in the cover 16 surrounding the central artificial decoration device 3. The three LEDs 4 are equidistantly arranged among the holes 18. The three LEDs 4 respectively emit red, green and blue light and three or two LEDs 4 may light at the same time or only one LED 4 may light at one time. The three LEDs 4 regularly alternate to light. When the control pole 28 is located at the ON1 or ON2 position, the LEDs 4 light.

The music player is disposed inside the base 2 and can store a plurality of different songs therein. When the control pole 28 is located at the ON2 position, the music player sounds.

When the control pole 28 is located at the ON2 position, the nozzles 19 surrounding the central artificial decoration device 3 all spurt water columns towards the central artificial decoration device 3. The height of the water columns is varied regularly. The three LEDs 4 regularly alternate to light.

When the control pole 28 is located at the ON1 position, all the nozzles 19 spurt water columns towards the central artificial decoration device 3, wherein the height of the water columns are varied regularly, the three LEDs 4 regularly alternate to light, and the music player plays the plurality of songs.

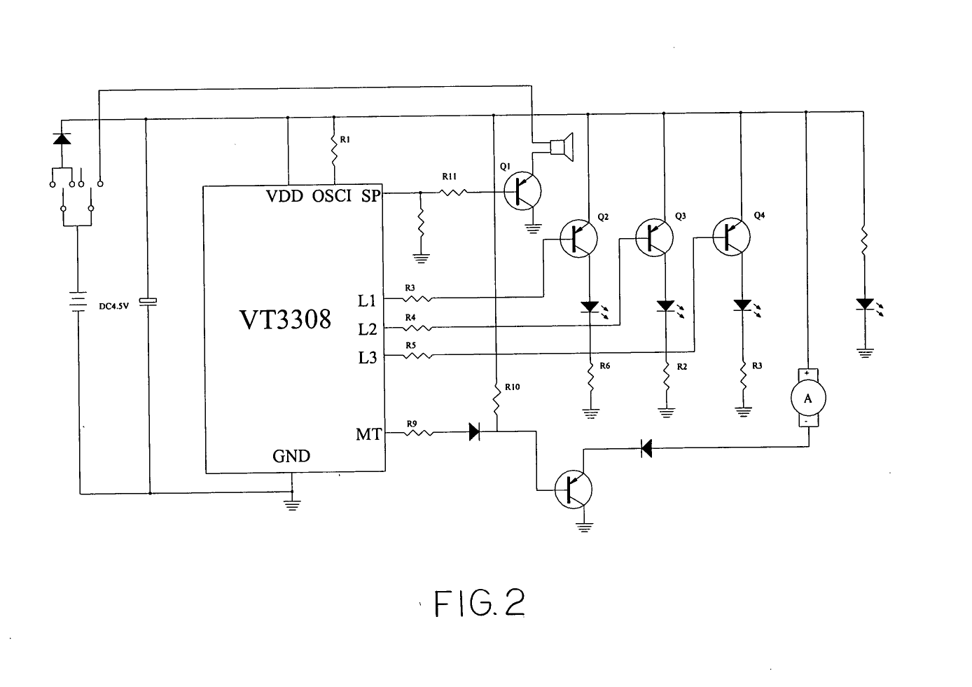

In the present invention, the principle and implementing method to enable the nozzle 19 to spurt water, the LED 4 to light and regularly alternate and the music player to store and play songs are known by one skilled in the art and so are not described in detailed herein. The circuit diagram shown in FIG. 2 is for more detailedly understanding the present invention.

The indoor fountain of the present invention may be put on a table, a windowsill, a pedestal, or the ground. The indoor fountain of the present invention not only provides the traditional look and feel of a fountain indoors, but also beautifies the home environment and has functions of emitting colored light and playing music through the LEDs 4 and the music player. Furthermore, the water columns, light and music are regularly varied. Therefore, the indoor fountain of the present invention offers more amusement and provides better enjoyment than a conventional fountain.

The preferred embodiments, aspects, and features of the invention have been described in detail. It will be apparent to those skilled in the art that numerous variations, modifications, and substitutions may be made without departing from the spirit of the invention as disclosed and further claimed below.

What is claimed is:

1. An indoor fountain comprising a basin, a base, a central artificial decoration device, and a plurality of LEDs disposed on a cover, characterized in that: the basin comprises a bowl-shaped body, the cover is disposed on the top of the basin body, a hollow water tank is defined between the cover and the basin body, the base is disposed under the bottom of the basin, a control switch is disposed on the base, the central artificial decoration device is disposed in the center of the top surface of the cover, a plurality of holes is defined in the cover surrounding the central artificial decoration device, a plurality of nozzles is defined in the cover surrounding the central artificial decoration device, the nozzles are connected to the water tank, when the control switch is turned on, the nozzles spurt water from the water tank and the LEDs emit light.

2. The indoor fountain as claimed in claim 1, wherein the LEDs surrounding the central artificial decoration device are equidistantly arranged among the holes.

3. The indoor fountain as claimed in claim 1, wherein the LEDs respectively emit different colors of light and regularly alternate to light.

4. The indoor fountain as claimed in claim 1, further comprises an audible music player.

5. The indoor fountain as claimed in claim 4, wherein the music player is disposed at the inside of the base and stores a plurality of different songs.

6. The indoor fountain as claimed in claim 1, wherein the control switch is defined with a recess, a control pole is disposed in the recess and is settable to three positions, ON1, OFF and ON2, in the recess for achieving three different functions.

7. The indoor fountain as claimed in claim 6, wherein when the control pole is set to the ON1 position in the recess, the nozzles spurt water columns, the LEDs emit light, and the music player plays music; and when the control pole is set to the ON2 position in the recess, the nozzles spurt water columns and the LEDs emit light.

8. The indoor fountain as claimed in claim 1, wherein the height of the water columns spurted from the nozzles is varied regularly.

9. The indoor fountain as claimed in claim 7, wherein the height of the water columns spurted from the nozzles is varied regularly.

10. The indoor fountain as claimed in claim 1, wherein a power jack is defined in the base.

11. The indoor fountain as claimed in claim 1, wherein the central artificial decoration device is disposed in the center of the top surface of the cover, a seat is disposed at the bottom of the central artificial decoration device, and a decoration member is disposed at the top of the seat.
